(19) United States
(12) Patent Application Publication
(10) Pub. No.: US 2014/0324598 A1
(43) Pub. Date: Oct. 30, 2014

(54) Product Sample Distribution System

(71) Applicant: Michael Scott Freeman, Smyrna, GA (US)

(72) Inventor: Michael Scott Freeman, Smyrna, GA (US)

(21) Appl. No.: 13/870,974

(22) Filed: Apr. 25, 2013

(51) Int. Cl. G06Q 30/02; G06Q 50/00

(52) U.S. Cl. CPC G06Q 30/0277; G06Q 30/0273; G06Q 50/01
USPC 705/14.69; 705/14.73

(57) ABSTRACT

A product sample distribution system provides a method and system for consumers and social media follower to initiate, accept and approve delivery of product samples using the Internet and provides free product samples using a social media platform connected to the product sample distribution system. The product sample distribution system also provides a system for brands to distribute product samples and collect targeted data and analysis regarding the product sample and the consumer.

### FIELD OF THE INVENTION

Certain embodiments of the invention relate to a product sample distribution system. More specifically, certain embodiments of the invention relate to a method and system for consumers to initiate, accept and approve delivery of free product samples using the Internet, connected media platforms, and a distribution system for brands to provide free product samples to connected users without incurring the typical initial costs associated with conducting a free product sample campaign. The product sample distribution system also provides a system for brands to distribute product samples and collect targeted data and analysis regarding the product sample and the consumer.

### BACKGROUND OF THE INVENTION

Product sampling is the traditional method used by brands to provide product samples to consumers. This traditional method of promotion is used to expose a consumer to a product with the expectation that the consumer will become a buying consumer of the sampled product. Additionally, giving away free product samples is a common method by which consumers become introduced to products from various brands.

Product sampling is an important promotional method for exposing consumers to products and is widely used by brands to launch new products and related services. Additionally, free product sampling is the method used by brands to increase consumer awareness for products that are experiencing decreased sales. However, the current methods of free product sampling that are available in the prior art have exorbitant cost associated with it, and often become too expensive for brands to initiate or operate. The associated operational costs to run a successful sampling campaign are often prohibitively expensive. For example, costs related to the delivery of product samples include packing and shipping costs, distribution costs, and manufacturing costs. The steady rising costs of consumer goods attribute to rising costs of advertising and marketing. The bulk of these costs are often amortized into the final selling price of the product being sampled, therefore to manage price increases brands will engage in traditional sampling campaigns.

Other methods of delivering product samples available in the prior art include using direct mailing methods. Use of direct mailing methods can be used to communicate with a brands target audience while attempting to obtain new consumers for brand's products. Direct mailing methods allow the brand to physically place free product samples with new consumers, however the cost of delivering the product samples remains costly, and offers limited ability for the brand to communicate or interact with the targeted consumers. Methods using direct mailing also are problematic because they do not allow the brand to gather any information from the consumer regarding the success of the product sampling campaign. To add, direct mailing methods do not allow the brand to track whether the targeted consumer had any interest in the free product sample. Moreover, direct mailing methods require large amounts of free product samples to be delivered in order to increase the effectiveness of the sampling campaign. Unfortunately, direct mailing methods still do not provide a guarantee that the targeted household or consumer has any interest in the underlying product.

Other methods of delivering product samples available in the prior art include using in-store distribution. The most typical type of in-store distribution includes providing free product samples distributed in a grocery store. In-store distribution methods are effective at saving on the operational cost of sampling campaigns because the brands incur minimal costs associated with fulfillment of the product sample. Additionally, in-store products samples are effective at gaining the consumers immediate attention for certain products. Nevertheless, in-store product sampling campaigns contain several inherent limitations. First, due to limited information with which to effectively target the distribution of product samples to consumers receiving the product sample through in-store distribution, the product samples are often delivered to any and all consumers, rather than to targeted consumers that are most likely interested in the product. Secondly, obtaining feedback from the consumers that received the product samples regarding the effectiveness of the product sample is usually non-existent as consumers usually take a free sample without providing any interaction or useful information regarding the product sample during in-store product sampling campaigns.

Another method used to deliver product samples is to advertise the free product sample using the Internet and social media websites. Both brands and advertisers use the Internet and social media websites to engage their consumers, as the Internet and social media allows brands to easily reach consumers to communicate about a product. For example, the brand may ask consumers to ‘like’ their brand on Facebook to generate a response or run an ad on its website asking consumers to fill out a free sample form. Unfortunately, these methods of distributing free product samples often result in the free product sample being consumed by consumers that have no brand loyalty or interest in purchasing the brand's product, and only have an interest in obtaining free products. Thus, the brand will receive no value from the product sampling campaign and will incur the cost for fulfilling orders to an untargeted group of consumers.

Consumers have become overwhelmed by receiving advertisements from multiple brands for products and related services that they have no interest in consuming. The inundation of unsolicited advertisements has resulted in consumers being overloaded with messaging regarding the various brands associated with the products. However, for brands faced with the challenges of effectively operating a product sampling campaign with the current methods, there is a need for a method and system that allows brands to cost effectively provide free product samples to targeted consumers. Additionally, there exists a need for brands to benefit by receiving targeted data regarding free product sampling campaigns.

Accordingly, it is an object of this invention to provide a product sampling method and system, which provides an improved method of distributing a free product sample to a consumer using the Internet, while also providing data regarding targeted consumers, and overcoming one or more of the aforementioned problems of existing systems. Thus, the invention also provides an apparatus for enabling a product sampling distribution method and system to distribute free product samples to consumers.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A method and/or product sample distribution system for consumers to initiate, accept and approve delivery of product samples via the Internet, and to provide a distribution system for free product samples to consumers using social media platforms connected to the product sample distribution system. The product sample distribution system also provides a system for brands to distribute product samples and collect targeted data and analysis regarding the product sample and the consumer, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a flow chart illustrating exemplary steps involved in providing a product sample distribution system, in accordance with an embodiment of the invention.

FIG. 2 is a block diagram illustrating an exemplary sample distribution platform, Gatekeepers, in communication with the Internet through a network, software application and sample database, in accordance with an embodiment of the invention.

FIG. 3 is a block diagram illustrating an exemplary sample distribution platform, in communication with the Internet through a network, and at least one Internet connected media device, in accordance with an embodiment of the invention.

FIG. 4 is a flow chart illustrating exemplary steps of providing access to a sampling campaign to the distributor, and the distributor querying the sample database for a listing of sampling campaigns and related product samples available to the distributor, in accordance with an embodiment of the invention.

FIG. 5 is a block diagram illustrating exemplary steps of querying the sample database for a listing of sampling campaigns and related product samples.

FIG. 6 is a block diagram illustrating another embodiment of the present invention, wherein the product sample distribution system comprises a website, Swaghookup.com, in communication with a social media influencer, and a social media follower via the Internet through a network, and at least one Internet connected media device.

FIG. 7 illustrates an exemplary product sample distribution system, comprising Swaghookup.com in communication with the sample distribution platform, Gatekeepers, in accordance with an embodiment of the invention.

FIG. 8 illustrates an exemplary website for Swaghookup.com with interactive content, in accordance with an embodiment of the invention.

FIG. 9 illustrates an exemplary website for Swaghookup.com with interactive content, in accordance with an embodiment of the invention.

### DETAILED DESCRIPTION OF THE INVENTION

Certain embodiments of the invention relate to a product sample distribution system. More specifically, certain embodiments of the invention relate to a method and system for consumers to initiate, accept and approve delivery of free product samples via the Internet using a social media platform connected to the product sample distribution system, wherein the product distribution system delivers the product samples directly to the consumer via download, directed method, secured carrier, or the like. The product sample distribution system also provides a system for brands to distribute product samples and collect targeted data and analysis regarding the product sample and the consumer.

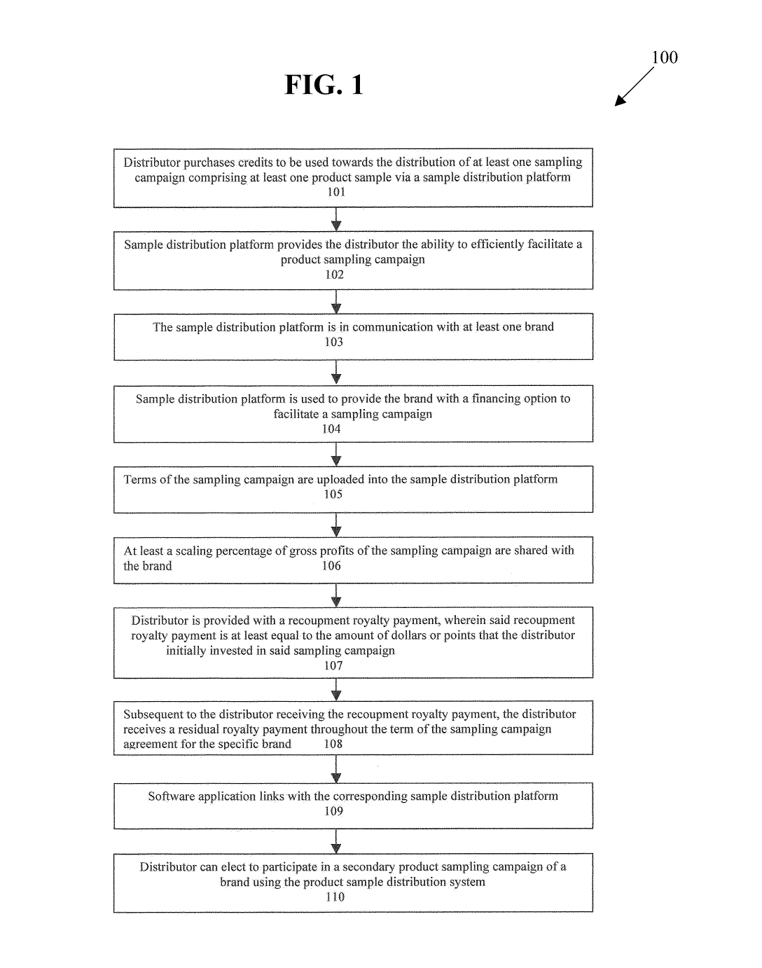

FIG. 1 depicts a flow chart illustrating exemplary steps involved in providing a product sample distribution system 100, in accordance with an embodiment of the present invention. At step 101, a distributor 210 purchases credits to be used to secure a number of samples for the distribution of at least one sampling campaign comprising at least one product sample using a sample distribution platform 220. In this particular example, the sample distribution platform 220 is referred to as Gatekeepers, and provides a distribution interface between the distributor 210, brand 230, consumers and/or the like in connection with the product sample distribution system 100. The distributor 210 comprises any entity that secures a number of samples for the sampling campaign. At step 102, the sample distribution platform 220 provides the distributor 210 the ability to efficiently facilitate the product sampling campaign. At step 103, the sample distribution platform 220 is in communication with at least one brand 230. Alternatively, multiple product samples can also be distributed simultaneously for a plurality of brands 230. In another embodiment of the present invention, the sample distribution platform 220 is in communication with the brand's 230 online presence via a website or the like using an Internet connected media device 212, 232. At step 104, the sample distribution platform 220 is used to provide the brand 230 with a sampling campaign agreement to facilitate the brand's sampling campaign. The terms of the sampling campaign can be predetermined or negotiated separately with the brand 230. The terms of the sampling campaign agreement will vary based on factors that include the pricing, segmentation, and availability of the product samples. At step 105, the terms of the sampling campaign may be uploaded into the sample distribution platform 220. At step 106, at least a scaling percentage of revenue of the sampling campaign can be shared with the distributor 210 through the payment of a royalty payment. At step 107, the distributor 210 is provided with a recoupment royalty payment, wherein said recoupment royalty payment is at least equal to the cost of the product samples secured by the distributor 210 to participate in said sampling campaign. At step 108, subsequent to the distributor 210 receiving the recoupment royalty payment, the distributor 210 receives a residual royalty payment throughout the term of the sampling campaign agreement. In one embodiment of the present invention, the recoupment royalty payment is 80% percent of the revenue the Gatekeepers system 100 earns from the total products sold, post completion of the sampling campaign. The total number of products sold can be equal to the total number of product samples distributed in the sampling campaign. The term of the engagement with the brand 230 can be based on the total number of units distributed in the sampling campaign. The residual royalty payment is 20% of the revenues earned by the Gatekeepers system 100 from the sales of units post the completion of the sampling campaign, for all product sales after the distributor 210 recoupment royalty payment is equal to at least the distributors 210 initial cost to secure the product samples distributed in the sampling campaign. For example, if 100,000 free product samples are distributed in said sampling campaign, then the Gatekeepers system 100 can receive 80% of the adjusted gross profits (AGP) for the first 20% of sales or 20K units, then 40% of the AGP for the next 30% of sales or 30K units, then 20% of the AGP for the remaining 50% of sales or 50K units. The distributors 230 will receive 80% of Gatekeepers system's 100 revenue until this portion of their royalty payment is equal to their expenditure to purchase samples, after they will receive a 20% royalty payment on Gatekeepers system 100 revenues through the term of the contract with the particular brand 230. In another embodiment of the present invention, the Gatekeepers system 100 can allow the specific brand 230 to receive 20% of the adjusted gross profits (AGP) for the first 20% of sales or 20,000 sales based on an 100K unit baseline, then 60% of the AGP for the next 30% of sales or 30,000 sales based on an 100K unit baseline, and 80% of AGP for the remaining 50% of sales or 50,000 sales based on an 100K unit baseline for the contracted term. Revenue refers to the income generated from product sales after the particular sampling campaign is complete. Profit refers generally to the total revenue minus total expenses in a given period for the particular sampling campaign. Operational expenses related to managing, facilitating, and fulfillment of the particular sampling campaign can be recouped before payment of any royalty to the distributor 210. At step 109, a software application 226 links with the corresponding sample distribution platform 220. At step 110, the distributor 230 can elect to participate in a secondary or a plurality of product sampling campaigns of any particular brand 230 using the product sample distribution system 100. The sample distribution platform 220 provides the distributor 210 the ability to participate in a crowd purchasing financing option, wherein the plurality of distributors 210 can secure a number of samples for the particular sampling campaign. This method of sample purchasing provides the brand 230 with the ability to operate larger sampling campaigns that are generally provided by much larger brands 230, and as a result, brands 230 of all sizes including small to midsized brands 230, benefit from significantly lower costs related to operating the sampling campaign. The crowd purchasing financing provided by Gatekeeper's sample distribution platform 220 protects the participating brands 230 from the expenses related to the fulfillment of the sampling campaign, and allows the brand 230 to continue focusing on the quality of its products and running daily operations. And a result, brands 230 can participate in more frequent and larger sampling campaigns, driving increased consumer awareness and brand loyalty.

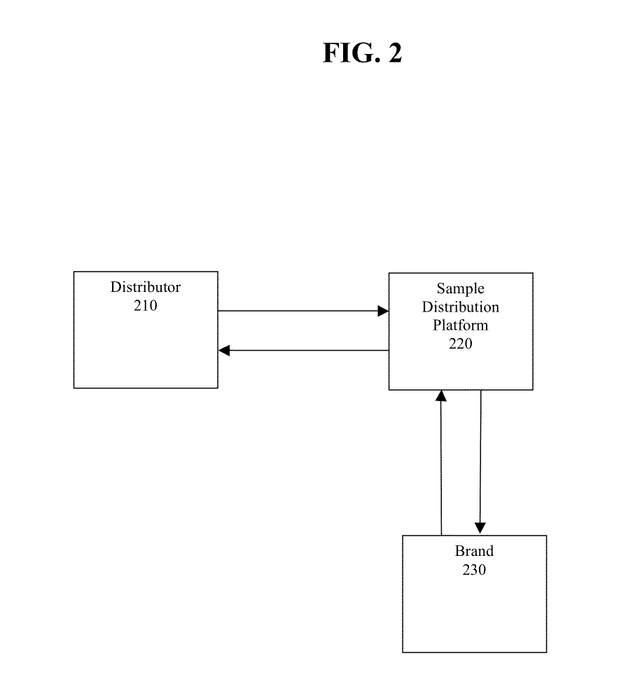

FIG. 2 is a block diagram illustrating an exemplary sample distribution platform 220, Gatekeepers, in communication with the Internet through a network 222, software application 226 and sample database 224, in accordance with an embodiment of the invention. Referring to FIG. 2, the wireless network 222 is in communication with the sample distribution platform 220 to provide the distributor 210 with access to the available sampling campaigns. In this embodiment, data related to the available sampling campaigns is accessible in the sample database 224 and may be accessed by distributors 210 via the wireless network 222. Additionally, brands 230 may access data related to sampling campaigns listed in the sample database 224. The network 222 then retransmits the sampling campaign data, at the request of the distributor 210 or brand 230 connected to the product sample distribution system 100. For instance, the sample distribution platform 220 in communication with the network 222 may comprise a wireless communications terminal that communicates wirelessly with the Internet and wirelessly or through wires to a public switched phone network, wide area network, local area network, or otherwise, that is connected to the sample database 224. The network 222 may also communicate with the Internet connected media device 212, 232 over wires. For example, the sample distribution platform 220, may be connected to a computer system via a universal serial bus (USB) port, or otherwise, and the computer system may be connected to a local area network (LAN), wide area network (WAN), public switched telephone network (PSTN), or otherwise. The LAN, WAN, PSTN, or otherwise, may communicate directly to the server or through additional networks.

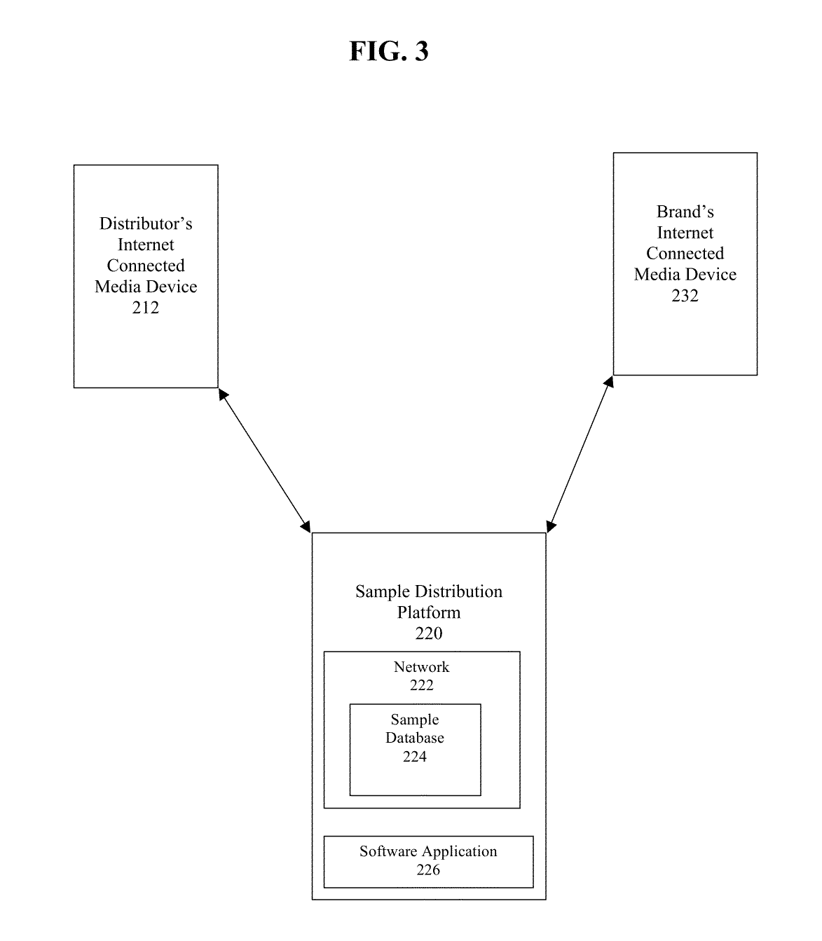

FIG. 3 is a block diagram illustrating an exemplary sample distribution platform 220, in communication with the Internet through the network 222, and at least one Internet connected media device 212, 232 of the distributor 210 and/or the brand 230. The network 222 can comprise a processor and a memory. The product sample distribution system 100 can communicate with the software application 226, in communication with the sample database 224. The software application 226 may include computer readable software and a server engine for causing the network 222 to communicate with the sample distribution platform 220. The software application 226 may be downloadable from the brand's online experience, website, or an application store such as the Apple App Store, Google Play Store or the like. In an alternate embodiment, the sampling campaign data may be stored on a secondary device, such as a computer and/or the like, or within the brand 230 or distributor's 210 accounts in connection with the software application 226.

The product sample distribution system 100 provides at least one distributor 210 with the ability to engage in purchasing a number of samples for at least one sampling campaign comprising at least one brand 230. A product sample can include any product and/or related service of at least one brand 230, which may or may not be exclusive to the sample database 224. The product sample distribution system 100 provides value to the distributor 210 that has an interest in financing the sampling campaign of the particular brand 230, and allows the distributor 210 to increase its revenues by financing a profitable sampling campaign. The product sample distribution system 100 also provides value to the brand 230 by delivering product samples at no cost to the consumers of the brand 230. Thereby, the product sample distribution system 100 creates an efficient system that can be used to distribute product samples, while also reducing cost for the brand 230 in the distribution and fulfillment of product samples. Fulfillment is the process of delivering product samples to consumers of the brand's 230 products and/or related services. For example, using the product sample distribution system 100, the brand 230 can send 100,000 free product samples to consumers without incurring any charges. In another embodiment of the present invention, the product sample distribution system 100 can provide at least one distributor 210 with the ability to interactively communicate with a plurality of brands 230. Brands 230 can include corporations, media publishers and/or the like, using the system 100 to delivery free product samples to the consumer.

In one embodiments of the present invention, the distributor's 210 Internet connected media device 212 may be operable to enable the available sampling campaigns of the brand 230 or the brand's 230 online experience to display, utilizing the product sample distribution system 100, within a section of an online experience, interactive product samples on the distributor's 210 Internet connected media device 212. The distributor's 210 Internet connected media device 212 may be operable to enable, utilizing the product sample distribution system 100, the distributor 212 to engage with the interactive sampling campaigns.

In another embodiment of the present invention, the product sample distribution system 100 can include analytics components that can be used to determine which distributors 210 are interacting with certain brands 230 or product samples, and which sampling campaigns the distributors 210 are participating in the sample database 224. Analytic information and data collected by the product sample distribution system 100 may also be used to communicate with third-party partners/advertisers. Analytic data provides the brand 230 with future opportunities for targeted advertising within a specific social network, to ensure its advertisements reach an audience that has already indicated an interest in its products. Additionally, the system 100 provides real-time or near real-time data on campaign performance and consumer feedback, allowing brands 230 to be more responsive to consumer wants, desires and perceptions. The product sample distribution system 100 can also provide the ability to map data into a rewards analytics engine of the sample database 224. Although not shown in FIG. 3, the product sample distribution system 100 may communicate with one or more advertisement servers. The advertisement servers may be utilized to deliver advertisement overlays to the software application 226 running on the Internet connected media device 212, 232. The advertisement servers may also be operable to support the tracking of user impressions and click-through and/or to perform other advertising-related functions. The product sample distribution system 100 may utilize one or more technologies to fulfill requests that occur in connection with the software application 226 and any distributor 210 or brand 230. Examples of such technologies may comprise, but need not be limited to, coupon delivery technologies, technologies for movie ticket purchases and delivery, and/or short message service/multimedia messaging service (SMS/MMS) gateways.

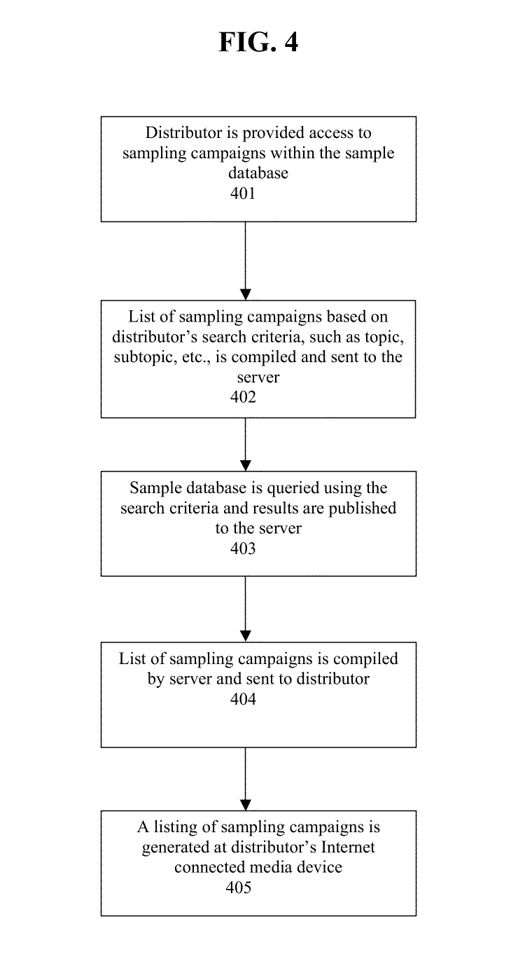

Illustrative steps involved in providing a sampling campaign to the distributor 210 is depicted in FIG. 4, in accordance with an embodiment of the invention. At step 401, the distributor 210 is provided access to the sampling campaign listed in the sample distribution platform 220. This access can provide a link that allows the distributor 210 to automatically access a list of sampling campaigns from the sample database. At step 402 a set of search criteria is assembled. Step 402 may occur at the distributor's 210 Internet connected media device 212, or at a remote server, such as a server in connection with the sample database 224. In addition, portions of the search criteria, such as a distributor's 210 profile, or topics related to the sampling campaign or the associated product sample that may reside on the remote server, as opposed to the Internet connected media device 212. After this information is compiled the database is queried at step 403. This query can be implemented in many manners, including use of a SQL database and query. At step 404, a set of related information of the sampling campaign, is determined. The sampling campaign can include any type of data based on distributor's 210 preferences. The sampling campaign and related data is provided to the server and then relayed to the distributor 210 at step 405. It should be acknowledged that the format in which the sampling campaign data is presented can be determined at the server, at the distributor's 210 Internet connected media device 212.

It should be recognized that the query need not occur at a dedicated server, such as the server connected to the sample database 224. Applications for media devices, such as programs, can be queried from those entities, which regularly provide mobile device applications, or organizations that test, review and publicize such applications. It should be understood that these databases may be affiliated or unaffiliated. In the case that they are unaffiliated, a primary server is used to coordinate communication to the servers and aggregating results of the parallel queries. It should also be understood that this process can occur at the same time the requests and receives any information or link related to the sampling campaign, after the user has explicitly chosen to receive sampling campaign data or other product sample related data from the sample database, or using other variations with respect to when the process occurs. User includes, but not limited to, the distributor 210, brand 230, consumer, and/or the like.

The Internet connected media device 212, 232 may comprise suitable logic, circuitry, interfaces and/or code that may be operable to receive data related to the sampling campaign, such as the display, screen, or controlling interface of said Internet connected media device 212, 232. The data related to the sampling campaign may comprise interactive data for interaction by the user 210, 230. In addition to receiving data related to the sampling campaign via the product sample distribution system 100, the Internet connected media device 212, 232 may receive sampling campaign data from the Internet via the communication network 222. In an exemplary embodiment of the invention, the Internet connected media device 212, 232 may comprise suitable logic, circuitry, interfaces and/or code that may be operable to provide sampling campaign data to automatically communicate with the product sample distribution system 100, via the communication network 222, to send sampling campaign data to the Internet connected media device 212, 232. In an exemplary embodiment of the invention, the Internet connected media device 212, 232 may be operable to enable an online experience to display, utilizing the product sample distribution system 100, within a section of the online experience, interactive content related to certain sampling campaign data being presented by the Internet connected media device 212, 232. In addition, the size of the section may be changed responsively based on information included in the interactive content. The location of the section online experience may be changed based on browsing experience of the user such as, for example, searching sampling campaigns, accessing product samples or browsing sample database. In an exemplary embodiment of the invention, the Internet connected media device 212, 232 may comprise a browser or other means to manage sampling campaigns or an online experience using the sample distribution platform 220. The online experience may be enabled by the user of the Internet connected media device 212, 232 utilizing the product sample distribution system 100, to display, within a section of the online experience, interactive sampling campaigns being financed or being presented to the user 210, 230.

The Internet connected media device 212, 232 may comprise suitable logic, circuitry, interfaces and/or code that may be operable to pair with the sample distribution platform 220. Communication between the sample distribution platform 220 and the Internet connected media device 212, 232 may occur via a wireless communication protocol such as, for example, Wi-Fi or near field communication (NCF). Those with skill in the art will understand that the network of the Internet connected media device 212, 232 can also be configured to utilize Bluetooth or other similar technology. The Internet connected media device 212, 232 may pair with the sample distribution platform 220 utilizing the companion software application 226 downloaded in the Internet connected media device 212, 232. For example, the companion software application 226 may comprise a sync application downloaded in the Internet connected media device 212, 232 from the sample distribution platform 220. The Internet connected media device 212, 232 may comprise, for example, a mobile phone, smartphone, tablet, laptop, MP3 player, computer, TV, cable set top box, game console, and consumer appliance.

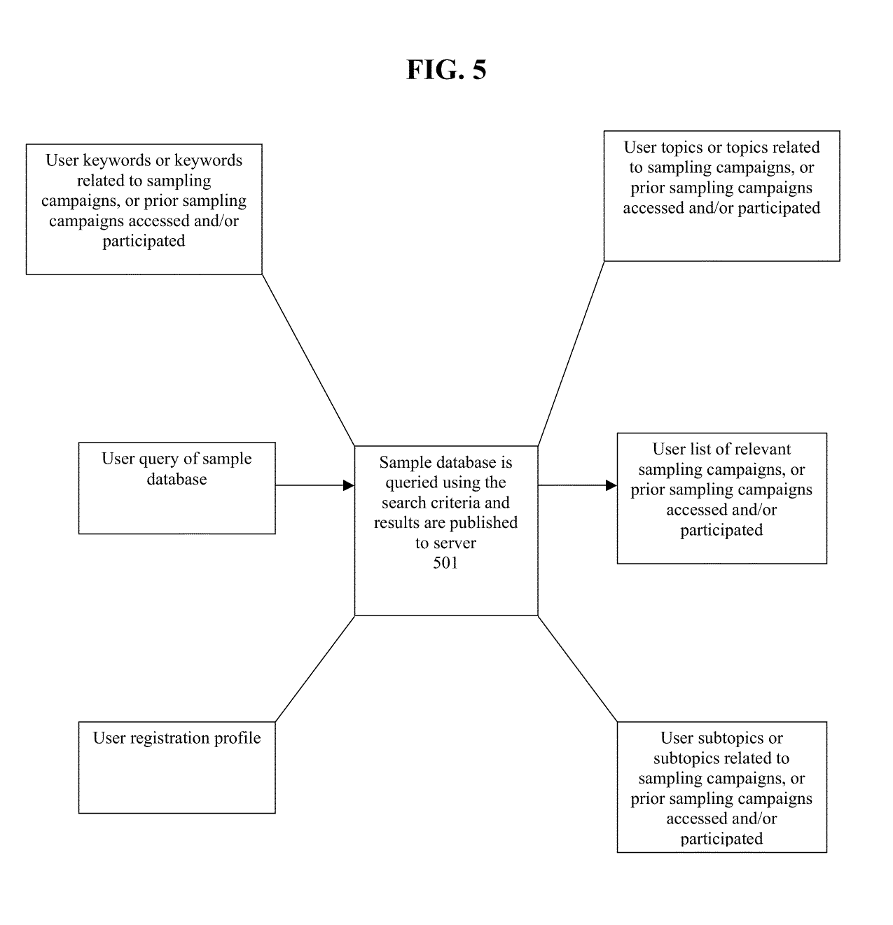

FIG. 5 graphically depicts the method by which the sample database 224 may be queried to provide a list of sampling campaigns and related product sample data to the user 210, 230. A number of criteria, such as the type of sampling campaign being financed or accessed by the user 210, 230 subtopics and keywords from the sampling campaign or prior sampling campaigns, may all be used to query database 501. The query may access information related to past, present and future sampling campaigns that the user 210, 230 may have an interest. In addition, the query may take into account registration information of the user 210, 230 input into the sample database 224, which may contain information specific to the user 210, 230 such as may contain user's 210, 230 interest, business, location, or statistical information regarding prior sampling campaigns financed or prior royalty payments received by the user 210, 230. The user 210, 230 profile can be completed upon registration to the product sample distribution system 100, changed subsequent to user's 210, 230 registration, or based on the distributor's 210 sampling campaign history. The user's 210, 230 profile can be analyzed and used by a query through typical means, such as the entry of a login and password, or through the use of data saved by the user's 210, 230 browser or other Internet access system. In addition, the user's 210, 230 Internet Service Provider can use their unique Internet Protocol address, or an alternate network identifier to determine the user 210, 230 querying information. A query of the sample database 501 making use of all, or any subset of these criteria, will yield a display of sampling campaigns or related product sample data to be provided to the user 210, 230.

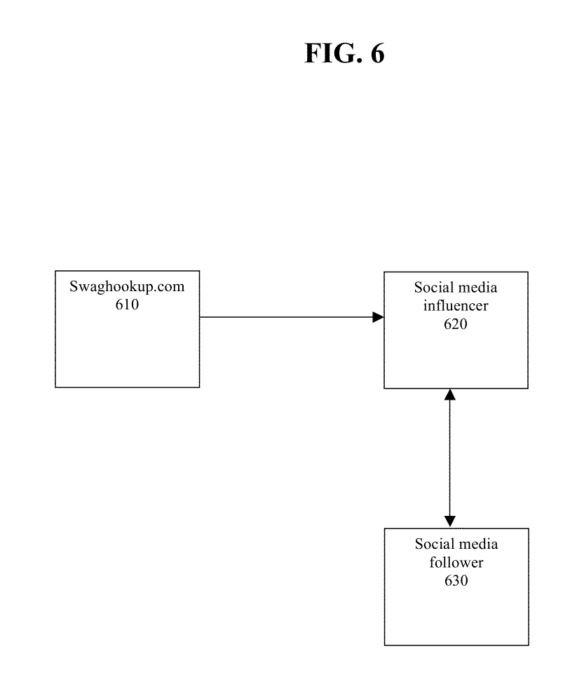

FIG. 6 is a block diagram illustrating another embodiment of the present invention, wherein the product sample distribution system 100 comprises a website, Swaghookup.com 610, in communication with a social media influencer 620, and a social media follower 630 via the Internet through a network, and at least one Internet connected media device 212, 232. The website is branded as Swaghookup.com 610, wherein Swaghookup.com 610 is a platform designed to allow the social media influencer 620 to share a product sample of the brand 230 to the social media followers 630 of the particular social media influencer 620. Additionally, Swaghookup.com 610 provides a platform that allows the brand 230 to gauge the interaction and collect data from social media followers 630 regarding its product samples. Social media followers 630 include, but are not limited to, fans, consumers, users of the brand's 230 products, or any user of a social media platform, system, or the like. Social Media Influencer 620 includes a celebrity, blogger, organization such as a brand, corporation, media publisher, or any user of a social media platform, system, or the like that has a following at least one person using said social media platform. Product samples shared by the social media influencer 620 can be referred to as swag. Swag includes any free product samples that the social media influencer 620 shares from the brand 230. Swag also includes any free products shared by the social media influencer in any capacity. Swaghookup.com 610 allows social media followers 630 to engage, hook-up or follow any social media influencer 620 and receive notifications regarding any free product samples. The social media follower 630 can also elect to input information or comments related to products samples or other sampling campaigns of the social media influencer 620. In one embodiment of the present invention, the social influencer 620 can include the brand 230, corporation, or media publisher. In this example, a media publisher like Pandora, Netflix, or Hulu can operate as a social influencer 620 to provide a subscription sponsorship that will provide free samples to its social media followers 620. For instance, social media followers 620 can receive a branded box of free samples, and in exchange for receiving the branded box of free samples; a subscription fee of the social media follower 620 can be paid or discounted. Additionally, the branded box of free samples can be branded using the system 100 as The Pandora Box by swaghookup.com.

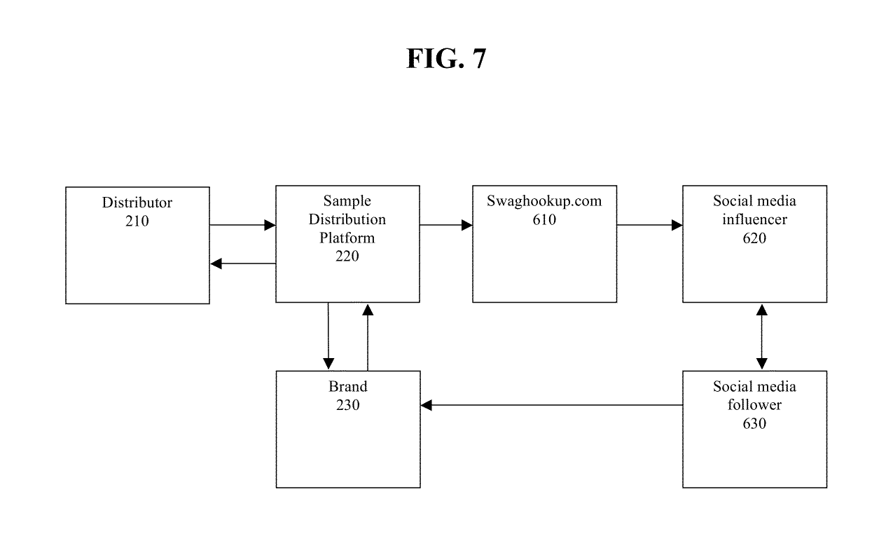

FIG. 7 illustrates an exemplary product sample distribution system 100, comprising Swaghookup.com 610 in communication with the sample distribution platform 220, Gatekeepers, in accordance with an embodiment of the invention. Swaghookup.com 610 allows the social media influencer 620 to engage its social media followers 630 using any social media platform such as, but not limited to Twitter, Facebook, Google+, Instagram, Myspace, Youtube, and/or the like. The ability for Swaghookup.com 610 to interface with social media platforms provides the ability to collect consumer data on behalf of the brands 230. For example, in one embodiment, the social media influencer 620 or product distribution system 100 may send a virtual questionnaire to the social media follower 630 related to the particular sampling campaign. The data collected can be used to discern the social media follower's 630 interest in the desired product sample or other related product samples. Additionally, the brand 230 can collect information to determine the social media follower's 630 interest relating to the product sample, the effectiveness of the sampling campaign, or any advertisements related to the particular sampling campaign.

Swaghookup.com 610 can also be utilized to collect media analytics within embodiments of the social media follower's 630 feedback related to certain sampling campaigns. In one embodiment, the brand 230 may desire to know public opinions related to their product samples, e.g., brand name products, new products, and/or the like. For example, the brand 230, e.g., Nike, may want to know the social media followers 630 reaction about a new product sample, such as a running shoe. In another embodiment, Swaghookup.com 610 may be used to collect data from the social media platforms. For example, Swaghookup.com 610 may obtain Tweets about social media followers 630 comments on the new running shoe from Nike. In yet another example, Swaghookup.com 610 may obtain Facebook fan comments, (e.g., fan “like” of Nike's running shoe “ ” page, news feed, etc.) from Facebook.

In another embodiment, the social media follower 630 may populate social media feeds to the social media network, wherein the social media followers 630 friends may view his status, knowing what product sample or sampling campaign the social media follower 630 is accessing, electing to “like,” “dislike,” and/or comment on his status, and/or the like. For example, in one embodiment, a software application for Swaghookup.com 610 may comprise a social feature so that the social media follower 630 may input a social media message. In another embodiment, Swaghookup.com 610 may automatically generate a social media message based on a pre-populated message format (e.g., a Tweet format with hashtags, etc.) and also send a message indicating the social media followers 630 product sample delivery status to the social media, which may automatically populate a social media status update. In such cases, the social media platform may request social media follower 630 authorization for Swaghookup.com 610 to access, e.g., download social data or send social data to social media, etc. Swaghookup.com 610 may obtain a social media follower 630 token for authorization to access the social media followers 630 social media profile, and/or the like.

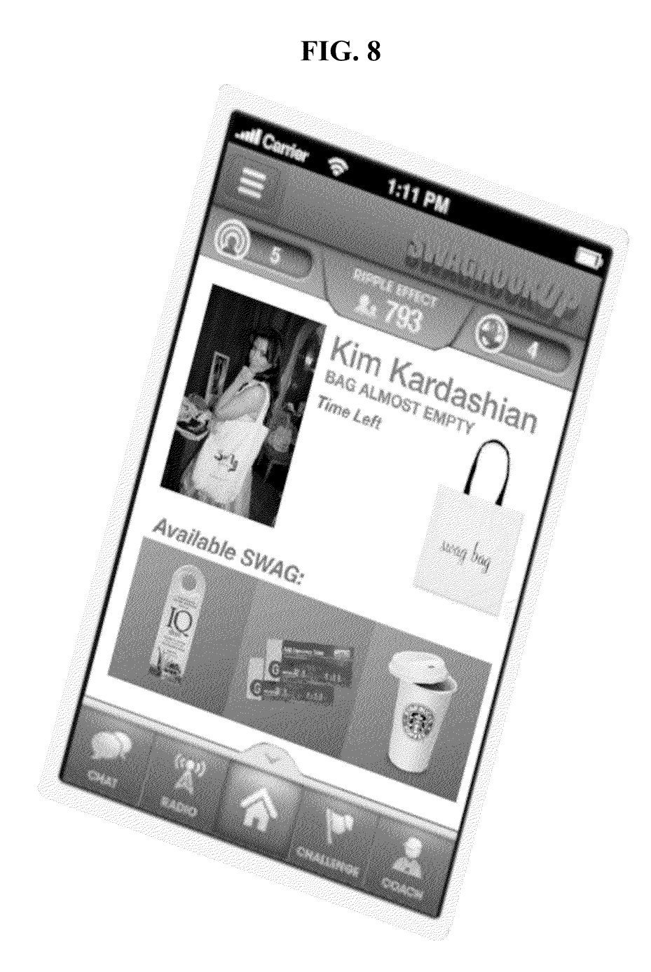

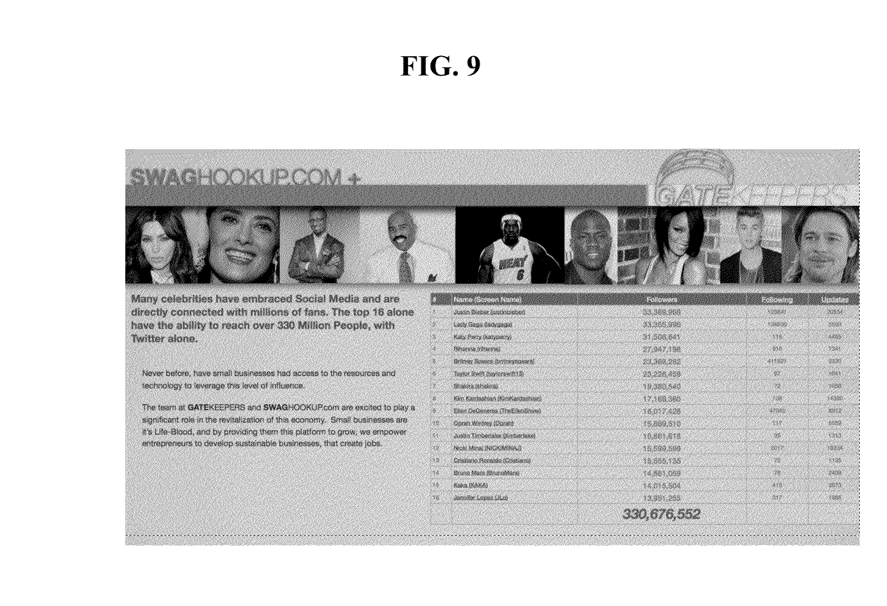

FIG. 8-9 illustrates an exemplary website Swaghookup.com 610, in accordance with an embodiment of the invention. In this example, Swaghookup.com 610 is shown on an Internet connected media device of the social media follower 630 using the Swaghookup.com App. Referring to FIG. 8, the social media influencer, Kim Kardashian, is using Swaghookup.com 610 to provide free product samples to social media followers 630, wherein the social media followers 630 are provided an index of exclusively free product samples that are available in a virtual swag bag. The free product samples available in the virtual swag bag include products from Starbucks, AMC movies, and IQ energy shot. Swaghookup.com 610 allows the social media influencer 620 to receive a virtual swag bag to house any free product samples available for distribution to the social media follower 630. The virtual swag bag houses any available swag, free products, or hook ups that can be distributed to the social media follower 630. The social media follower 630 and social media influencer 620 can accumulate points or credits for any free product samples that are respectively retrieved from said virtual swag bag by the social media follower 630 or shared by the social media influencer 620. In addition, the accumulate credits are referred to as a swag credit, and provides value to the social media influencer 620 for each product sample distributed to the social media follower 630 from said virtual swag bag. Alternatively, a swag credit is provided to the social media follower 630 for each free sample redeemed or received from the virtual swag bag. The swag credits may be used towards the purchase of the brand's 230 products, thereby creating a passive stream of residual income. In one embodiment of the present invention, the social media followers 230 can earn points or credits that can be used towards purchases, however the social media followers 230 may not convert those points to cash. Additionally, the swag credits can be stored on a credit card, debit card, stored value card, secured card, or the like, wherein payments or credits can be engaged in any manner can be used to store or redeem accumulated points or credits.

In another embodiment of the present invention, the social media follower 630 can register to participate to receive a free product sample via data transmitted a computer network in communication with Swaghookup.com 610. For example, the social media follower 630 can access Swaghookup.com 610 using an invitation to an online registration. The social media follower 630 can use any Internet connected media device to access Swaghookup.com 610 and communicate with the product sample distribution system 100. During registration the social media follower 630 can provide data including name, postal address, and e-mail address. Additionally, the social media follower 630 can provide other information including occupation, product sample preferences, demographic information, and the like. Registration enables Swaghookup.com 610 to regularly transmit data to the social media follower 630 notifying the social media follower of upcoming product samples and other related production information. For instance, the social media follower 630 can elect to receive notifications when the swag bag of a certain social media influencer is filled with free product samples. The collected social media follower registration data is stored in a database in communication with Swaghookup.com 610.

Fulfillment of an order can be finalized after the social media follower 630 elects to participate to receive a free product sample via Swaghookup.com 610. Fulfillment includes the process of delivering a product sample to the social media follower 630, wherein social media follower 630 includes a consumer, general user, or the like. Fulfillment is used to describe the act of distribution or the logistics related to the distribution of product sample. Swaghookup.com 610 is used to generate all the requisite social media follower 630 information and data to deliver the product sample, which may include the social media follower's 630 mailing address data and data indicating the social media follower's 630 preferred delivery hours. Product samples can be delivered via standard U.S. mail, federal express, united parcel service, foreign country postal service, electronically or a third party delivery service. Alternatively, the delivery process can be completely or partially subcontracted to a third party mailing or fulfillment company. In another embodiment of the present invention, delivery of a product sample can include delivery of a virtual coupon to redeem a free product sample. For example, sending the social media follower 230 a link to print or download a coupon from Swaghookup.com 610, or via the social media follower's 630 email can complete the delivery of the free product sample. Social media follower's 630 can also elect to receive additional information regarding coupons or deals related to product samples to use towards the purchase of the brand's 230 products. In another embodiment of the present invention, delivery of a product sample can include delivery of the product sample to a store of the brand 230, wherein the social media follower 630 can pick-up the free product sample.

Referring to FIG. 9, Swaghookup.com 610 can comprise a plurality of celebrities 620 to provide free products to a plurality of social media followers 630. In this particular embodiment, the celebrities include Justin Beiber, Lady Gaga, Katy Perry, Rihanna, Britney Spears, Taylor Swift, Shakira, Kim Kardashian, Ellen DeGeneres, Oprah Winfrey, Justin Timberlake, Nicki Minaj, Cristiano Ronaldo, Bruno Mars, Kaka and Jennifer Lopez. The product sample distribution system 100 provides a method for celebrities 620 to provide their social media followers 630 with free products for multiple brands 230 and related or unrelated products. Swaghookup.com 610 allows the social media influencer 620 to effectively manage its social media followers and offer targeted samples. For example, the social media influencer 620 can use the product sample distribution system 100 to provide offers for exclusive free product samples to social media followers 230 based on the registration data of the social media follower 630. Additionally, the social media influencer 620 can be paired with the specific brand 230 to effectively distribute the brand's 230 free product samples and related products. Therefore, the brand 230 is incentivized to employ the product sample distribution system 100, and the social media influencer 610 is positioned to convert more social media followers 630 into consumers of the brand's 230 products.

In accordance with an embodiment of the present invention, the sample database 224 can be used to provide a combination of free product samples to social media followers 630. The rewards can include multiple categories of products representative of various brands 230 and retailers. For example, the categories can include free product samples for food, clothing, health care, and travel. Also, social media followers 630 can search the sample database 224 to find offers for free product samples. Brands 230 can use the sample database 224 to offer one or more free product samples for any defined time period. For example, the brand 230 can offer free product samples for a 30-day period, wherein the social media influencer is required to send at least four notifications regarding the particular sampling campaign and related products to social media followers 630 via Swaghookup.com 610. The social media influencer 620 can send notifications using Swaghook.com 610, the Swaghookup APP, or any combination of social media, traditional media, and/or the like. These notifications are designed to alert the social media followers 630 of ongoing sampling campaigns and to collect real-time feedback regarding the related product samples. Brands 230 also may decide to discontinue any sampling campaign or free product sample based on preferences, or use social media follower 630 data.

In accordance with an embodiment of the present invention, the product sample distribution system 100 can automatically send the distributor 210 a notification regarding the terms and conditions of the sample campaign, and to send any information regarding any free product samples offered by the brand 230. In an exemplary embodiment of the invention, the product sample distribution system 100 can provide a sampling campaign strategy for brands 230 that do not currently use a sampling campaign. Additionally, the product sample distribution system 100 provides distributors 210 a business opportunity to participate in the growth of brands 230 that will likely increase sales of the related products and/or services. The product sample distribution system 100 allows the brands 230 to provide full sampling campaigns to the social media followers 630, in a strategic manner, and also allows the brands 230 to reach social media followers 630 in local and national locations. Thus, the product sample distribution system 100 can be used to create additional revenue for both distributors 210, brands 230 and social media influencers 620, provide free product samples to social media followers 630, and allow the social media influencer 620 to grow and stabilize its social media follower base through promoting free product samples. The product sample distribution system 100 allows any distributor 210 to purchase a plurality of product samples for the brand's 230 sampling campaign. Additionally, the product sample distribution system 100 allows the brand 230 of any consumer products to utilize the system 100 to distribute product samples.

In an exemplary embodiment of the invention, certain sampling campaign may comprise an advertisement of a particular free product sample. In one aspect of the invention, content may comprise a link to a website, online reference, online database, and/or other information related to the particular free product sample. In another aspect of the invention, upon searching for an item related to the particular free product sample by the social media follower 630, the online experience may comprise a list of links to websites and/or online references related to the particular free product sample. The interactive sampling campaign may comprise a link to a particular website and/or online references with information on the particular free product sample shown in the advertisement, and the link to the particular website and/or online reference may appear to be a first link on the list.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for linking content on an Internet connected media device and/or other Internet connection services.

Accordingly, the present invention may be realized in hardware, software, or a combination of hardware and software. The present invention may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose Internet connected computer system with a computer program that, when being loaded and executed, controls the computer system such that it carries out the methods described herein.

The present invention may also be embedded in a computer program product, which comprises all the features enabling the implementation of the methods described herein, and which when loaded in an Internet connected computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method of distributing free product samples using an Internet connected media device connected to a social media platform in communication with a social media influencer, comprising:
enabling a distributor to purchase a product sample for the distribution of at least one sampling campaign comprising at least one product sample using a sample distribution platform, wherein the sample distribution platform allows the distributor to efficiently facilitate the sampling campaign;
providing at least one brand in communication with the sample distribution platform;
enabling the brand to enter a sampling campaign agreement to facilitate the sampling campaign, wherein the sample distribution platform is in communication with the brand's online presence via a website using the Internet connected media device; and
providing at least one royalty payment to said distributor from revenue of the sampling campaign.

2. The method according to claim 1, wherein the royalty payment provided comprises a recoupment royalty payment that is at least equal to the cost of the product samples purchased by the distributor to participate in said sampling campaign.

3. The method according to claim 1, wherein the royalty payment provided comprises a residual royalty payment that is at least received throughout the term of the sampling campaign agreement.

4. The method according to claim 2, wherein the recoupment royalty payment is based from a percentage of the revenue earned from the total products sold, wherein the total products sold is equal to the total number of product samples distributed in the sampling campaign.

5. The method according to claim 3, and the residual royalty payment is based from a percentage of the revenue earned from the total product sold after the recoupment royalty is paid during the term of the sampling campaign agreement, wherein the total product samples sold is equal to the total number of product samples distributed in the sampling campaign.

6. The method according to claim 1, wherein the sampling campaign agreement comprises at least one term having a predetermined time period, predetermined sales value or predetermined pricing.

7. The method according to claim 1, further comprising the step of enabling the terms of the sampling campaign agreement to be uploaded into the sample distribution platform.

8. The method according to claim 1, further comprising the step of providing at least one free product sample of the sampling campaign to a consumer using said sample distribution platform.

9. The method according to claim 1, further comprising the step of enabling a software application to link with the corresponding sample distribution platform.

10. The method according to claim 1, further comprising the step of enabling the distributor to participate in a plurality of sampling campaigns using the sample distribution platform.

11. The method according to claim 1, further comprising the step of enabling the sample distribution platform to provide the distributor the ability to participate in a crowd purchasing financing option.

12. The method according to claim 1, further comprising the step of enabling the brand to provide a user to automatically receive updates related to said sampling campaign.

13. The method according to claim 1, wherein said sampling campaign comprises an advertisement related to the sampling campaign.

14. The method according to claim 1, wherein said sampling campaign comprises a link to an online sample database and/or other information related to said sampling campaign.

15. An apparatus for distributing free product samples to a social media follower comprising:
an online experience comprising at least one link to a sample database consisting of at least one product sample;
an Internet connected media device;
a social media influencer in communication with the sample database and a social media network;
a software application in communication with the sample database and the Internet connected media device, wherein the software application allows the social media follower to browse the sample database and use the link to query the sample database to identify at least one free product sample in the sample database;

17. The apparatus of claim 15, wherein the social media influencer sends at least one notification to the social media follower regarding the availability of free product sample using the social media network.

18. The apparatus of claim 15, comprising a sample distribution platform, wherein the sample distribution platform allows a distributor to secure a plurality of product samples for the distribution of at least one sampling campaign comprising at least one product sample of at least one brand in communication with the sample distribution platform.

19. The apparatus of claim 15, wherein the sample distribution platform is in communication with the brand's online presence via a website using the Internet connected media device.

20. The apparatus of claim 15, wherein the distributor receives at least one royalty payment from any revenue generated from the sampling campaign.

21. The method according to claim 15, wherein the social media follower receives at least one branded box of free product samples wherein a subscription fee of the social media follower is paid or discounted.

22. The apparatus of claim 15, wherein the Internet connected media device includes at least one Internet connected media device selected from the group comprising a mobile phone, smartphone, tablet, consumer appliance, MP3 player, game console, computer, cable set top box and television.

23. A product sample distribution system, comprising:
a sample distribution platform coupled to a product sample distribution system, said sample distribution platform being paired with or associated with an Internet connected media device utilizing a software application running on said Internet connected media device to provide a user an online experience, and wherein said Internet connected media device is operable to:
enable, utilizing said product sample distribution system, said online experience to display, within a section of an online experience, an interactive product sample related to the certain product sample being presented by said Internet connected media device;
enable, utilizing said product sample distribution system, the user to interact with said interactive product sample;
enabling, the sample distribution platform to allow a distributor to secure a plurality of product samples for the distribution of at least one sampling campaign comprising at least one product sample of at least one brand in communication with the sample distribution platform; and
providing at least one royalty payment to the distributor from any revenue generated from the sampling campaign.
